(19) United States
(12) Patent Application Publication
(10) Pub. No.: US 2014/0112401 A1
(43) Pub. Date: Apr. 24, 2014

(54) 3DYNAMIC CONFIGURATION OF AN N-PHASE POLARITY DATA COMMUNICATIONS LINK

(71) Applicant: QUALCOMM Incorporated, San Diego, CA (US)

(72) Inventors: George Alan Wiley, San Diego, CA (US); Glenn Raskin, San Diego, CA (US)

(73) Assignee: QUALCOMM Incorporated, San Diego, CA (US)

(21) Appl. No.: 14/138,921

(22) Filed: Dec. 23, 2013

Related U.S. Application Data
(63) Continuation-in-part of application No. 13/797,272, filed on Mar. 12, 2013.
Application No. 13/797,272 is a continuation-in-part of application No. 13/662,076, filed on Oct. 26, 2012.
Application No. 13/662,076 is a continuation-in-part of application No. 13/933,900, filed on Jul. 2, 2013.
(60) Provisional application No. 61/666,197, filed on Jun. 29, 2012.
(60) Provisional application No. 61/660,664, filed on Jun. 15, 2012.

(51) Int. Cl. H04B 3/04; H04B 1/04

(52) U.S. Cl. CPC H04B 3/04; H04B 1/04
USPC 375/259; 375/295

(57) ABSTRACT

System, methods and apparatus are described that facilitate transmission of data, particularly between two devices within electronic equipment. The apparatus may dynamically configure the communications link by determining a first set of connectors to carry a first data payload in a plurality of multi-phase signals, encoding the first data payload in a sequence of symbols, and transmitting the sequence of symbols on the first set of connectors. Each symbol may be characterized by a combination of phase state and polarity of a pair of connectors, and by a selection of at least one undriven connector. The number of connectors in the first set of connectors may be calculated to satisfy one or more of a bandwidth requirement and a maximum power consumption restriction.

### RELATED APPLICATIONS

The present application for Patent is a continuation-in-part of U.S. patent application Ser. No. 13/797,272 entitled “N-Phase Polarity Data Transfer” filed Mar. 12, 2013, which claims priority from U.S. Provisional Application No. 61/666,197 filed Jun. 29, 2012 and from U.S. Provisional Application No. 61/612,174 filed Mar. 16, 2012, and the present application is a continuation-in-part of U.S. patent application Ser. No. 13/662,076 entitled “Three-Phase-Polarity Safe Reverse Link Shutdown” filed Oct. 26, 2012, which claims priority from U.S. Provisional Application No. 61/660,664 entitled “Three-Phase-Polarity Safe Reverse Link Shutdown” filed Jun. 15, 2012, and the present application is a continuation-in-part of U.S. patent application Ser. No. 13/933,090 entitled “N-Phase Polarity Output Pin Mode Multiplexer” filed Jul. 1, 2013, which applications are assigned to the assignee hereof and are hereby expressly incorporated by reference herein.

### BACKGROUND

1. Field

The present disclosure relates generally to high-speed data communications, and more particularly, to dynamically configurable communications links between components of electronic devices including multi-phase encoded communications links.

2. Background

High-speed interfaces are frequently used between circuits and components of mobile wireless devices and other complex apparatus. For example, certain devices may include processing, communications, storage and/or display devices that interact with one another through communications links. Some of these devices, including synchronous dynamic random access memory (SDRAM), may be capable of providing or consuming data and control information at processor clock rates. Other devices, such as display controllers, may require variable amounts of data at relatively low video refresh rates. Communications devices such as radio frequency transceivers may be characterized by infrequent bursts of high volume data that data transferred at high data rates. High-speed communications links are often constructed to handle the highest expected throughput and are frequently over-provisioned.

High-speed communications links are often provisioned with multiple parallel connectors. Clock speeds on high-speed communications links may be limited by any number of factors, and higher throughputs are often attained by increasing the number of connectors in the communications link. However, each additional connector in the communications link can significantly increase power consumption by transmitters and receivers. Therefore, many designers are forced to balance throughput and power consumption. Typically, the designer specifies the bus width as a tradeoff between power consumption and throughput.

### SUMMARY

Systems, methods and apparatus are disclosed herein that use a communications link having a number of connectors that can be configured to be active as needed to support high data throughput and deactivated to conserve power when demand for bandwidth is decreased. The communications link may be provided between two devices that may be collocated in an electronic apparatus and communicatively coupled through one or more communications links.

In an aspect of the disclosure, a data transfer method includes steps of determining a first set of connectors to carry a first data payload in a plurality of multi-phase signals, encoding the first data payload in a first set of symbols, and transmitting the first set of symbols in a first sequence of symbol intervals on the first set of connectors. The first set of connectors may include a number of connectors calculated to satisfy one or more of a bandwidth requirement and a maximum power consumption restriction. Each symbol in the first set of symbols may be transmitted in a corresponding symbol interval by defining a phase state and a polarity of at least one pair of connectors in the first set of connectors and by refraining from driving at least one connector of the first set of connectors. A change of state of one or more connectors may occur at each transition between successive symbol intervals.

In an aspect of the disclosure, the method includes determining a second set of connectors to carry a second data payload in a plurality of multi-phase signals, encoding the second data payload in a second set of symbols, and transmitting the second set of symbols in a second sequence of symbol intervals on the second set of connectors. The second set of connectors may include a different number of connectors than the number of connectors in the first set of connectors. The first set of connectors and the second set of connectors may have at least one connector in common. The number of connectors in the first set of connectors may be selected to satisfy a temporary bandwidth requirement. The number of connectors in the second set of connectors may be selected to satisfy the maximum power consumption restriction. The maximum power consumption restriction may relate to an average power consumption. The total power consumed during transmission of the first data payload and the second data payload may satisfy the maximum power consumption restriction. Power consumed while transmitting the first set of symbols on the first set of connectors may exceed the maximum power consumption restriction.

In an aspect of the disclosure, a plurality of multi-phase drivers may be disabled when transmitting the second set of symbols. Information describing the first set of connectors may be communicated to a receiver of the first data payload. The information describing the first set of connectors may be communicated through a control channel or in a control packet. The information describing the first set of connectors may be communicated in preambles transmitted over the first set of connectors. The information describing the first set of connectors may be communicated in a training sequence over the first set of connectors.

In an aspect of the disclosure, transmitting the first set of symbols includes configuring a plurality of multi-phase drivers to drive the first set of connectors. Transmitting the first set of symbols may include operating a plurality of switches to cause an output of at least one of a plurality of multi-phase drivers to be coupled to a line driver. The line driver is configured to drive one of first set of connectors.

In an aspect of the disclosure, an apparatus may include means for determining a first set of connectors to carry a first data payload in multi-phase signals and for determining a second set of connectors to carry a second data payload in multi-phase signals, means for encoding the first data payload in a first set of symbols and for encoding the second data payload in a second set of symbols, and means for transmitting the first set of symbols in a first sequence of symbol intervals on the first set of connectors and for transmitting the second set of symbols in a second sequence of symbol intervals on the second set of connectors. The first set of connectors may include a number of connectors calculated to satisfy a temporary bandwidth requirement. The second set of connectors may comprise a number of connectors calculated to satisfy a maximum power consumption restriction. Each symbol in the first set of symbols and in the second set of symbols may be transmitted in a corresponding symbol interval by defining a phase state and a polarity of at least one pair of connectors and by refraining from driving at least one connector. A change of state of one or more connectors may occur at each transition between successive symbol intervals.

In an aspect of the disclosure, a non-transitory processor-readable storage medium may store one or more instructions. The one or more instructions, when executed by at least one processing circuit, may cause the at least one processing circuit to determine a first set of connectors to carry a first data payload in a plurality of multi-phase signals, encode the first data payload in a first set of symbols, and transmit the first set of symbols in a first sequence of symbol intervals on the first set of connectors. The first set of connectors may include a number of connectors calculated to satisfy one or more of a bandwidth requirement and a maximum power consumption restriction. Each symbol in the first set of symbols may be transmitted in a corresponding symbol interval by defining a phase state and a polarity of at least one pair of connectors in the first set of connectors and by refraining from driving at least one connector of the first set of connectors. A change of state of one or more connectors of the set of connectors may occur at each transition between successive symbol intervals.

In an aspect of the disclosure, a driver circuit may be adapted to dynamically configure a communications link in order to satisfy one or more of a bandwidth requirement and a maximum power consumption restriction. The driver circuit may include an encoder configured to generate a sequence of symbols from data to be transmitted on the communications link, a plurality of line drivers where each line driver is configurable to drive one or more connectors of the communications link, and a controller. Each symbol may be transmitted in a corresponding symbol interval by defining a phase state and a polarity of at least one pair of connectors of the communications link and by refraining from driving at least one connector of the communications link. The controller may be configured to determine a first set of connectors to carry a first data payload in a plurality of multi-phase signals on the communications link, configure a portion of the line drivers to couple the encoder to the first set of connectors, and activate the portion of the line drivers according to the sequence of symbols generated by the encoder. The first set of connectors may include a number of connectors calculated to satisfy the bandwidth requirement or the maximum power consumption restriction.

### BRIEF DESCRIPTION OF THE DRAWINGS

FIG. 1 depicts an apparatus that employs an N-phase polarity encoded data link between devices within the apparatus.

FIG. 2 illustrates a system architecture for an apparatus employing an N-phase polarity encoded data link.

FIG. 3 illustrates an example of an N-phase polarity data encoder.

FIG. 4 illustrates signaling in an N-phase polarity encoded interface.

FIG. 5 is a state diagram illustrating state transitions in the example of a 3-wire, 3-phase communication link.

FIG. 6 illustrates a 3-phase polarity data decoder.

FIG. 7 illustrates certain aspects of a communications system employing M-wire, N-phase polarity data encoding.

FIG. 8 is a schematic drawing showing a model of an encoder that transmits symbols using 6 wires with 2 pairs of wires driven for each state.

FIG. 9 illustrates an example of an application of M-wire, N-phase polarity data encoding used to replace conventional buses.

FIG. 10 illustrates an example of an apparatus adapted for a dynamically configurable encoding system.

FIG. 11 is a flow chart of a method for selective N-phase polarity encoding.

FIG. 12 is a diagram illustrating an example of a hardware implementation for an encoding apparatus employing N-phase polarity data encoding.

FIG. 13 is a diagram illustrating an example of a hardware implementation for a processing circuit used to configure a communications link according to certain aspects disclosed herein.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as, but not limited to hardware, firmware, a combination of hardware and software, software, or software in execution. For example, a component may be, but is not limited to being, a process running on a processor, a processor, an object, an executable, a thread of execution, a program and/or a computer. By way of illustration, both an application running on a computing device and the computing device can be a component. One or more components can reside within a process and/or thread of execution and a component may be localized on one computing device and/or distributed between two or more computing devices. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Certain disclosed examples relate to systems and apparatus that employ multi-phase data encoding and decoding methods involving a plurality of conductors (i.e., M conductors). The M conductors typically include three or more conductors, and each conductor may be referred to as a wire, although the M conductors may include conductive traces on a circuit board or within a conductive layer of a semiconductor integrated circuit (IC) device. The M conductors may be divided into a plurality of transmission groups, each group encoding a portion of a block of data to be transmitted. An N-phase encoding scheme is defined in which bits of data are encoded phase transitions and polarity changes on the M conductors. In one example, an N-phase encoding scheme for a 3-wire system may provide three phase states and two polarities, providing 6 states and 5 possible transitions from each state. Deterministic voltage and/or current changes may be detected and decoded to extract data from the M conductors. Decoding does not rely on independent conductors or pairs of conductors and timing information can be derived directly from phase and/or polarity transitions in the M conductors. N-Phase polarity data transfer can be applied to any signaling interface, such as electrical, optical and radio frequency (RF) interfaces, for example.

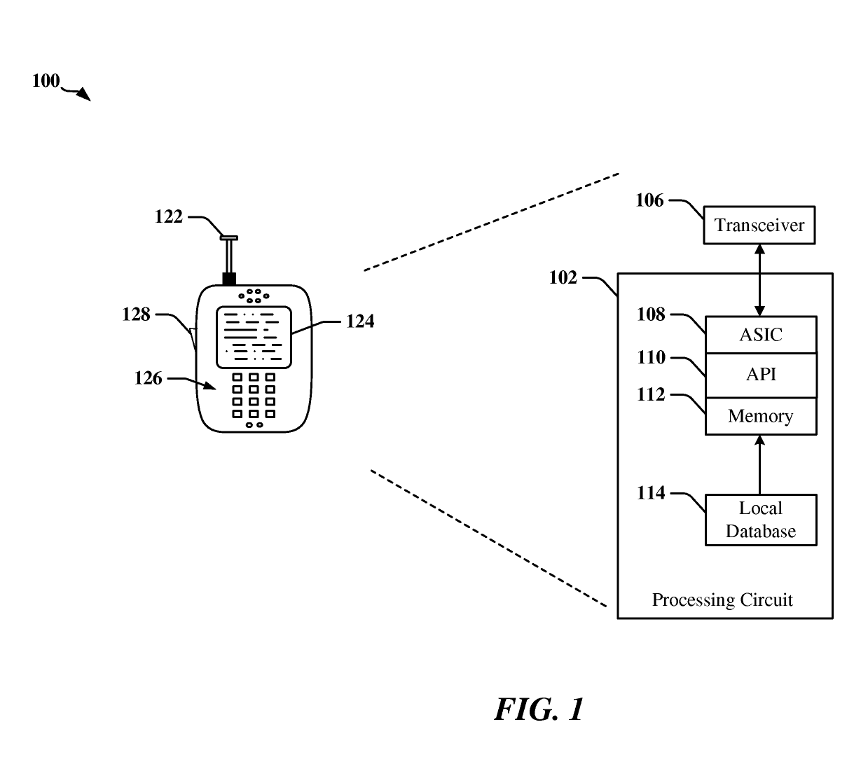

Certain aspects of the invention may be applicable to communications links deployed between electronic components, which may include subcomponents of devices such as telephones, mobile computing devices, appliances, automobile electronics, avionics systems, etc. Referring to FIG. 1, for example, an apparatus 100 employing M-wire, N-phase encoding may include a processing circuit 102 that is configured to control operation of the apparatus 100. The processing circuit 102 may access and execute software applications and control logic circuits and other devices within the apparatus 100. In one example, the apparatus 100 may include a wireless communication device that communicates through an RF communications transceiver 106 with a radio access network (RAN), a core access network, the Internet and/or another network. The communications transceiver 106 may be operably coupled to processing circuit 102. The processing circuit 102 may include one or more IC devices, such as an application specific IC (ASIC) 108. The ASIC 108 may include one or more processing devices, logic circuits, and so on. The processing circuit 102 may include and/or be coupled to processor readable storage 112 that may maintain instructions and data the may be executed by processing circuit 102. The processing circuit 102 may be controlled by one or more of an operating system and an application programming interface (API) 110 layer that supports and enables execution of software modules residing in storage 112 of the wireless device. The storage 112 may include read-only memory (ROM) or random-access memory (RAM), electrically erasable programmable read-only memory (EEPROM), a flash memory device, or any memory device that can be used in processing systems and computing platforms. The processing circuit 102 may include and/or access a local database 114 that can maintain operational parameters and other information used to configure and operate the apparatus 100. The local database 114 may be implemented using one or more of a database module or server, flash memory, magnetic media, EEPROM, optical media, tape, soft or hard disk, or the like. The processing circuit may also be operably coupled to external devices such as an antenna 122, a display 124, operator controls, such as a button 128 and a keypad 126, among other components.

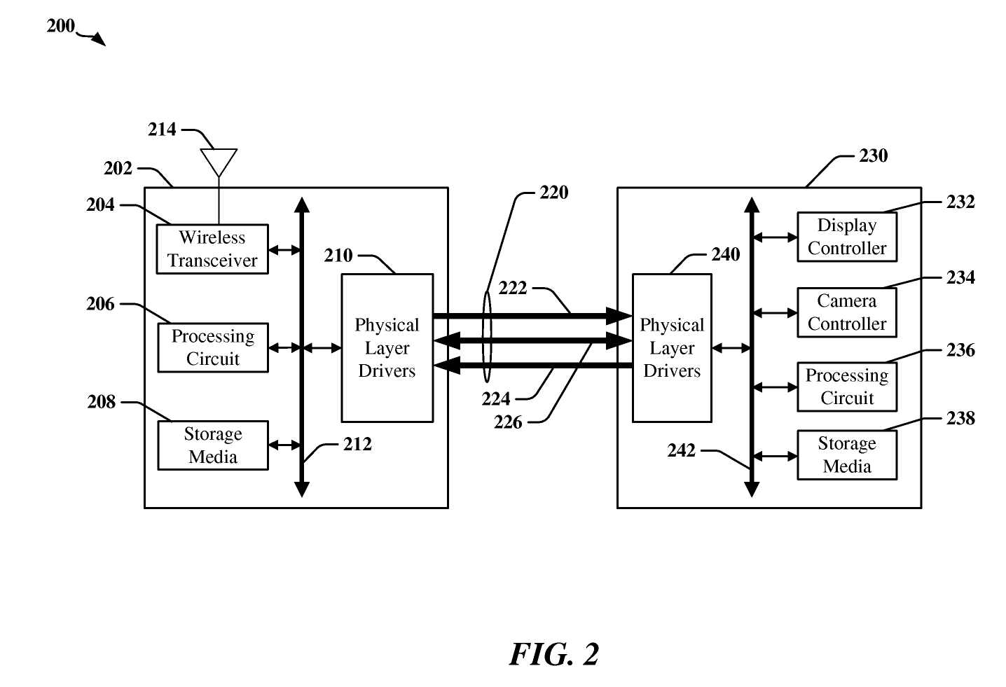

FIG. 2 is a schematic block diagram illustrating certain aspects of an apparatus 200 such as a wireless mobile device, a mobile telephone, a mobile computing system, a wireless telephone, a notebook computer, a tablet computing device, a media player, a gaming device, or the like. The apparatus 200 may include a plurality of IC devices 202 and 230 that exchange data and control information through a communications link 220. The communications link 220 may be used to connect the IC devices 202 and 222, which may be located in close proximity to one another or physically located in different parts of the apparatus 200. In one example, the communications link 220 may be provided on a chip carrier, substrate or circuit board that carries the IC devices 202 and 230. In another example, a first IC device 202 may be located in a keypad section of a flip-phone while a second IC device 230 may be located in a display section of the flip-phone. A portion of the communications link 220 may include a cable or optical connection.

The communications link 220 may provide or support multiple communications channels 222, 224 and 226. One or more communications channel 226 may be bidirectional, and may operate in half-duplex and/or full-duplex modes. One or more communications channel 222 and 224 may be unidirectional. The communications link 220 may be asymmetrical, providing higher bandwidth in one direction. In one example described herein, a first communications channel 222 may be referred to as a forward link 222 while a second communications channel 224 may be referred to as a reverse link 224. The first IC device 202 may be designated as a host, master and/or transmitter, while the second IC device 230 may be designated as a client, slave and/or receiver, even if both IC devices 202 and 230 are configured to transmit and receive on the communications link 222. In one example, the forward link 222 may operate at a higher data rate when communicating data from a first IC device 202 to a second IC device 230, while the reverse link 224 may operate at a lower data rate when communicating data from the second IC device 230 to the first IC device 202.

The IC devices 202 and 230 may each include a processor or other processing circuit or device 206, 236. In one example, the first IC device 202 may perform core functions of the apparatus 200, including maintaining wireless communications through a wireless transceiver 204 and an antenna 214, while the second IC device 230 may support a user interface that manages or operates a display controller 232, and/or controls the operation of a camera or video input device using a camera controller 234. Other features supported by one or more of the IC devices 202 and 230 may include a keyboard, a voice-recognition component, and other input or output devices. The display controller 232 may include circuits and software drivers that support a display such as a liquid crystal display (LCD) panel, a touch-screen display, an indicator and so on. The storage media 208 and 238 may include transitory and/or non-transitory storage devices adapted to maintain instructions and data used by the respective processing circuits 206 and 236, and/or other components of the IC devices 202 and 230. Communication between each processing circuit 206, 236, its corresponding storage media 208 and 238 and other modules and circuits may be facilitated by one or more bus 212 and 242, respectively.

The reverse link 224 may be operated in the same manner as the forward link 222. The forward link 222 and the reverse link 224 may be capable of transmitting at comparable speeds or at different speeds, where speed may be expressed as data transfer rate and/or clocking rates. The forward and reverse data rates may be substantially the same or may differ by orders of magnitude, depending on the application. In some applications a single bidirectional link 226 may support communications between the first IC device 202 and the second IC device 230. The forward link 222 and/or the reverse link 224 may be configurable to operate in a bidirectional mode when, for example, the forward and reverse links 222 and 224 share the same physical connections and operate in a half-duplex manner.

In certain examples, the reverse link 220 derives a clocking signal from the forward link 218 for controlling transmission, for synchronization purposes, for control purposes, to facilitate power management and/or for simplicity of design. The clocking signal may have a frequency that is obtained by dividing the frequency of a symbol clock used to transmit signals on the forward link 218. The symbol clock may be superimposed or otherwise encoded in symbols transmitted on forward link 218. The use of a clocking signal that is a derivative of the symbol clock allows fast synchronization of transmitters and receivers (transceivers 210, 230) and enables fast start and stop of data signals without the need for framing to enable training and synchronization.

In certain examples, a single bidirectional link 218 or 220 may support communications between first processing device 202 and the second processing device 222. In certain embodiments, the first processing device 202 and the second processing device 222 provide encoding and decoding of data, address and control signals transmitted between a processing device and memory devices such as dynamic random access memory (DRAM).

In one example, one or more of buses 212 and/or 232 may provide access to double data rate (DDR) SDRAM using M-wire, N-phase encoding technique. N-phase polarity encoding devices 210 and/or 230 can encode multiple bits per transition, and multiple sets of wires can be used to transmit and receive data from the SDRAM, control signals, address signals, and so on.

In another example, the communication link 220 includes a high-speed digital interface, such as a mobile display digital interface (MDDI), and one or more sub-links 222, 224 and/or 226 may use N-phase polarity encoding. The physical layer drivers 210 and 240 may include transceiver circuits configured to encode and decode data transmitted on the link 220. The use of N-phase polarity encoding provides high speed data transfer and may consume half or less of the power of other interfaces because fewer drivers are active in a typical N-phase polarity encoded data link. N-phase polarity encoding devices in the transceivers 210 and 240 can encode multiple bits per transition on an M-wire interface. In one example, a combination of 3-wire, 3-phase and polarity encoding may be used to support a wide video graphics array (WVGA) 80 frames per second LCD driver IC without a frame buffer, delivering pixel data at 810 Mbps for display refresh.

According to certain aspects disclosed herein, the encoding scheme and configuration of wires used to implement communications link 220 may be configured according to application and/or the operational capabilities of one or more IC devices 202, 230. In one example, the communications link 220 may be configured as a bus having a plurality of 2-wire differentially encoded links. In another example, the communications link 220 may be configured to operate using M-wire N-phase encoding. Certain aspects of the operation of the communications link 220 may be configured at time of manufacture or assembly of a device that includes the IC devices 202 and 230, including selecting between differential and N-phase encoding, for example. Certain aspects of the communications link 220 may be dynamically configured in response to one or more configuration parameters, switches or other settings. For example, the number and orientation (forward, reverse, bidirectional) of connectors and other aspects of the operation of the communications link 220 may be handled programmatically and/or in response to a command or change in configuration transmitted to one or more of the IC devices 202, 230.

According to certain aspects disclosed herein, characteristics of an M-wire, N-phase polarity encoded communications link may be dynamically modified to accommodate changing operational requirements and circumstances. For example, the number of wires used to transmit an N-phase signal may be increased to obtain a higher available bandwidth and/or the number of wires used to transmit an N-phase signal may be decreased to reduce power consumption by the IC devices 202 and 230. The number of wires used to transmit an N-phase signal in one direction may be adapted independently of the number of wires used to transmit an N-phase signal in the other direction.

Receiving circuits and transmitting circuits in the physical layer drivers 210 and 240 may be configured using control information transmitted when the communications link 220 is activated after hibernation or power-on. The control information may be transmitted according to a predefined protocol, whereby a minimum number of wires are activated to carry a control message specifying the configuration of the communications link 220, for example. The control message may alternatively or additionally be transmitted with a shutdown command, a wakeup command, and/or in a preamble preceding each transmission. In some examples, the configuration of the communications link 220 may be determined during a training and/or synchronization sequence, whereby the receiving physical layer drivers 210 or 240 monitors the available wires or other conductors for transitions corresponding to an N-phase signal, in order to determine which wires/conductors are active.

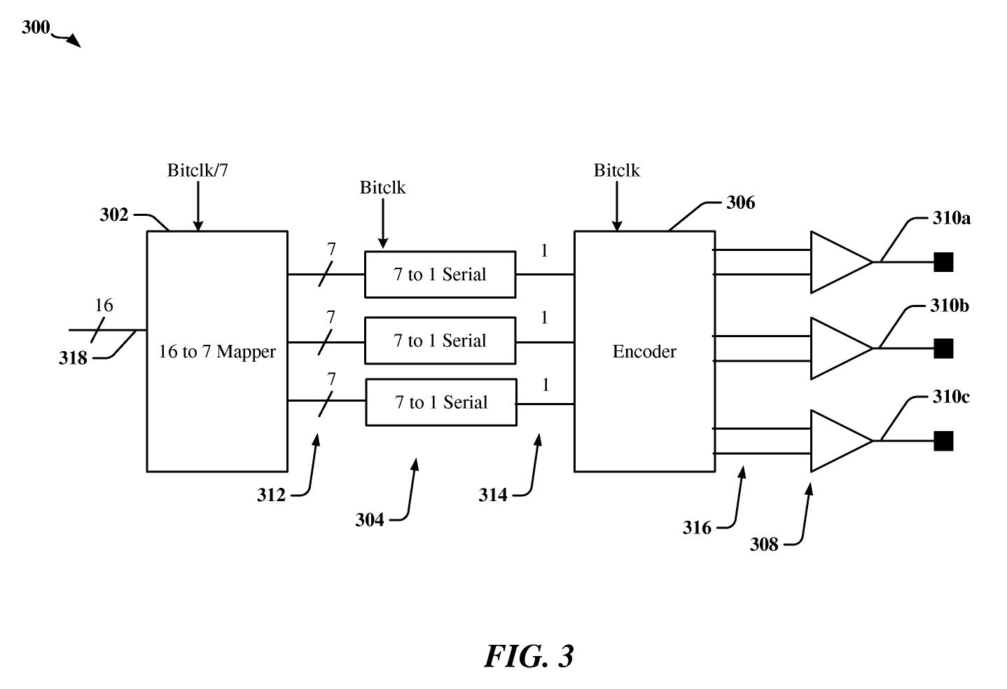

FIG. 3 is a diagram 300 illustrating an example of an M-wire, N-phase polarity encoding transmitter configured for M=3 and N=3. The example of 3-wire, 3-phase encoding is selected solely for the purpose of simplifying descriptions of certain aspects of this disclosure. The principles and techniques disclosed for 3-wire, 3-phase encoders can be applied in other configurations of M-wire, N-phase polarity encoders.

When N-phase polarity encoding is used, connectors such as signal wires 310a, 310b and 310c on an N-line bus may be undriven, driven positive, or driven negative. An undriven signal wire 310a, 310b or 310c may be in a high-impedance state. An undriven signal wire 310a, 310b or 310c may be driven to a voltage level that lies substantially halfway between the positive and negative voltage levels provided on driven signal wires. An undriven signal wire 310a, 310b or 310c may have no current flowing through it. In the depicted example, each signal wire 310a, 310b and 310c may be in one of three states (denoted as +1, −1, or 0) using drivers 308. In one example, drivers 308 may include unit-level current-mode drivers. In another example, drivers 308 may drive opposite polarity voltages on two signals 310a and 310b while the third signal 310c is at high impedance and/or pulled to ground or to a neutral or mid-level voltage. For each transmitted symbol interval, at least one signal is in the undriven (0) state, while the number of signals driven positive (+1 state) is equal to the number of signals driven negative (−1 state), such that the sum of current flowing to the receiver is always zero. For each symbol, the state of at least one signal wire 310a, 310b or 310c is changed from its state in the symbol transmitted in the preceding transmission interval.

In the example depicted in FIG. 3, 16-bit input data 318 is provided to a mapper 302, which maps the input data 318 to 7 symbols 312 for transmitting sequentially over the signal wires 310a, 310b and 310c. The 7 symbols 312 may be serialized, using parallel-to-serial converters 304 for example. An M-wire, N-phase encoder 306 receives the resultant sequence of the 7 symbols 312 and computes the state of each signal wire 310a, 310b and 310c for each symbol interval. The encoder 306 selects the states of the signal wires 310a, 310b and 310c based on the input symbol and the previous state of signal wires 310a, 310b and 310c.

The use of M-wire, N-phase encoding permits a number of bits to be encoded in a plurality of symbols where the bits per symbol is not an integer. In the simple example of a 3-wire system, there are 3 available combinations of 2 wires that may be driven simultaneously, and 2 possible combinations of polarity on the pair of simultaneously driven wires, yielding 6 possible states. Since each transition occurs from a current state, 5 of the 6 states are different and available for encoding the signal wires 310a, 310b and 310c at every transition. The state of at least one wire is required to change at each transition. With 5 states, log₂(5)≅2.32 bits may be encoded per symbol. Accordingly, a mapper may accept a 16-bit word and convert it to 7 symbols because 7 symbols carrying 2.32 bits per symbol can encode 16.24 bits. In other words, a combination of seven symbols that encode five states has 5⁷ (78,125) permutations. Accordingly, the 7 symbols may be used to encode the 2¹⁶ (65,536) permutations of 16 bits using the 78,125 available permutations.

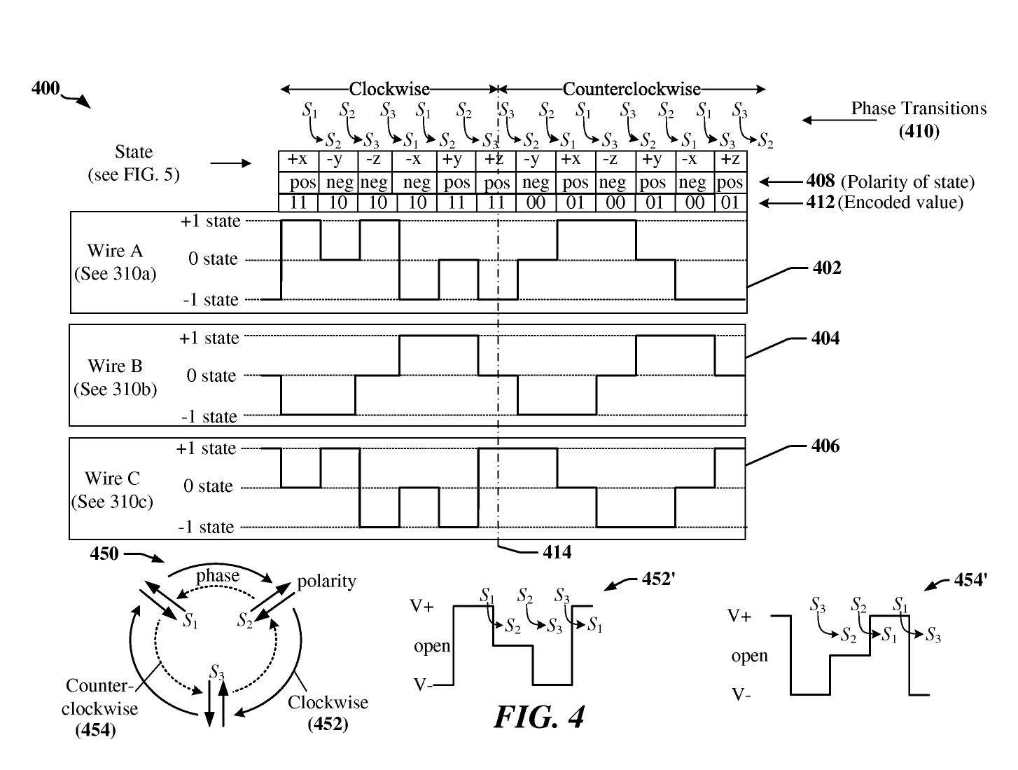

FIG. 4 illustrates an example of signaling 400 employing a three-phase modulation data-encoding scheme based on the circular state transition diagram 450. According to the data-encoding scheme, a three-phase signal may rotate in two directions and may be transmitted on three independently driven conductors 310a, 310b, and 310c. The three-phase signal transmitted on each of the three conductors 310a, 310b, 310c is 120 degrees out of phase relative to the three-phase signal transmitted on the other conductors 310a, 310b, 310c. At any point in time, each of the three conductors 310a, 310b, 310c is in a different one of the states {+1, 0, −1}. At any point in time, each of the three conductors 310a, 310b, 310c in a 3-wire system is in a different state than the other two wires. When more than three conductors or wires are used, two or more pairs of wires may be in the same state. The illustrated encoding scheme also encodes information in the polarity of the two conductors 310a, 310b and/or 310c that are actively driven to the +1 and −1 states. Polarity is indicated at 408 for the sequence of states depicted.

At any phase state in the illustrated three-wire example, exactly two of the conductors 310a, 310b, 310c carry a signal which is effectively a differential signal for that phase state, while the third conductor 310a, 310b or 310c is undriven. The phase state for each conductor 310a, 310b, 310c may be determined by voltage difference between each conductor 310a, 310b or 310c and the other conductors 310a, 310b and/or 310c, or by the direction of current flow, or lack of current flow, in the conductor 310a, 310b or 310c. As shown in the state transition diagram 450, three phase states (S₁, S₂ and S₃) are defined. A clockwise signal may flow from phase state S₁ to phase state S_{z}, phase state S₂ to phase state S₃, and/or phase state S₃ to phase state S₁. A counter-clockwise signal may flow from phase state S₁ to phase state S₃, phase state S₃ to phase state S₂, and/or phase state S₂ to phase state S₁. For other values of N, transitions between the N states may optionally be defined according to a corresponding state diagram to obtain circular rotation between state transitions.

In the example of a three-wire, three-phase link, clockwise rotations (S₁ to S₂), (S₂ to S₃), and/or (S₃ to S₁) at a state transition may be used to encode a logic 1, while counter-clockwise rotations (S₁ to S₃), (S₃ to S₂), and/or (S₂ to S₁) at the state transition may be used to encode a logic 0. Accordingly a bit may be encoded at each transition by controlling whether the signal is “rotating” clockwise or counter-clockwise. For example, a logic 1 may be encoded when the three wires 310a, 310b, 310c transition from phase state S₁ to phase state S₂ and a logic 0 may be encoded when the three wires 310a, 310b, 310c transition from phase state S₁ to phase state S₃. In the simple three-wire example depicted, direction of rotation may be easily determined based on which of the three wires 310a, 310b, 310c is undriven before and after the transition.

Information may also be encoded in the polarity of the driven conductors 310a, 310b, 310c or direction of current flow between two conductors 310a, 310b, 310c. Signals 402, 404, and 406 illustrate voltage levels applied to conductors 310a, 310b, 310c, respectively at each phase state in a three-wire, three-phase link. At any time, a first conductor 310a, 310b, 310c is coupled to a positive voltage (+V, for example), a second conductor 310a, 310b, 310c is coupled to a negative voltage (−V, for example), while the third conductor 310a, 310b, 310c may be open-circuited. As such, one polarity encoding state may be determined by the current flow between the first and second conductors 310a, 310b, 310c or the voltage polarities of the first and second conductors 310a, 310b, 310c. In some embodiments, two bits of data may be encoded at each phase transition. A decoder may determine the direction of signal phase rotation to obtain the first bit, and the second bit may be determined based on the polarity difference between two of the signals 402, 404 and 406. The decoder having determined direction of rotation can determine the current phase state and the polarity of the voltage applied between the two active connectors 310a, 310b and/or 310c, or the direction of current flow through the two active conductors 310a, 310b and/or 310c.

In the example of the three-wire, three-phase link described herein, one bit of data may be encoded in the rotation, or phase change in the three-wire, three-phase link, and an additional bit may be encoded in the polarity of two driven wires. Certain embodiments, encode more than two bits in each transition of a three-wire, three-phase encoding system by allowing transition to any of the possible states from a current state. Given three rotational phases and two polarities for each phase, 6 states are defined, such that 5 states are available from any current state. Accordingly, there may be log₂(5)≅2.32 bits per symbol (transition) and the mapper may accept a 16-bit word and convert it to 7 symbols.

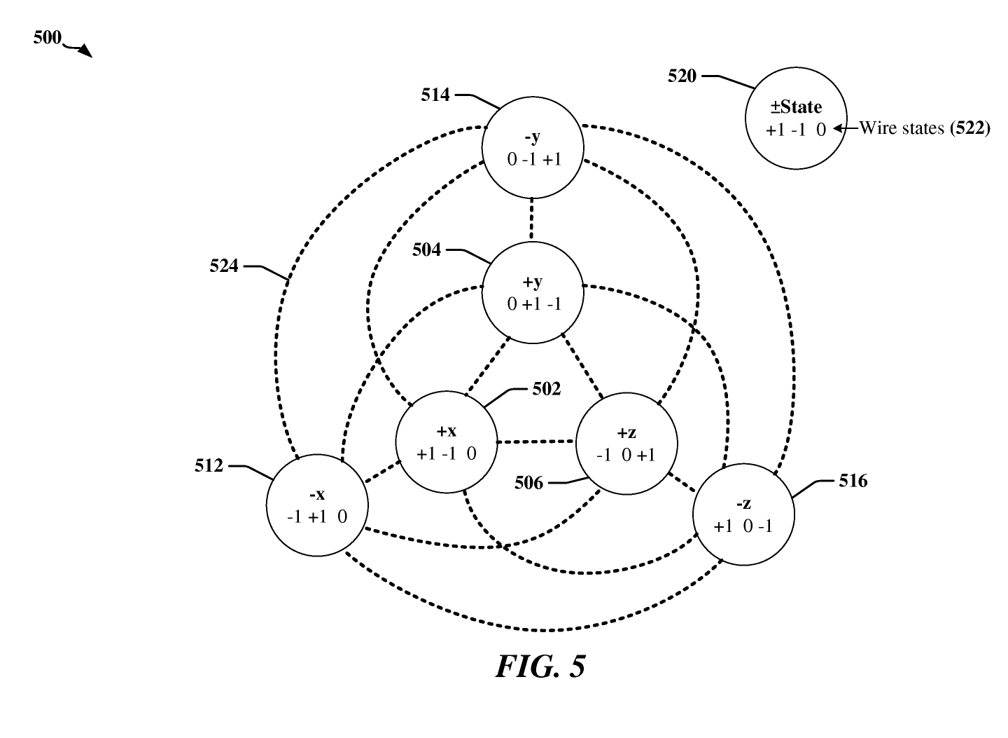

FIG. 5 is a state diagram 500 illustrating 6 states and 30 possible state transitions in the example of a 3-wire, 3-phase communication link. FIG. 5 expands on the state transition diagram 450 in FIG. 4 by depicting all possible states 502, 504, 506, 512, 514 and 516. These states 502, 504, 506, 512, 514 and 516 include positive polarity and negative polarity versions of the phase states S₁, S₂ and S₃ illustrated in the phase transition diagram 450 of FIG. 4. For clarity, the set of phase/polarity states are labeled alphabetically and includes {+x, −x, +y, −y, +z, −z} where, for example, +x and −x represent states with the same phase state but different polarity. As shown in the model state element 520, each state 502, 504, 506, 512, 514 and 516 in the state diagram 500 includes a field 522 showing the voltage state of signals 402, 404 and 406, which are transmitted on wires 310a, 310b and 310c, respectively. For example, in state 502 (+x) signal 402=+1, signal 404=−1 and signal 406=0. Also shown in FIG. 5 are the 5 possible transition paths available from each state 502, 504, 506, 512, 514 or 516 to each of the other states 502, 504, 506, 512, 514 and/or 516. For example, one transition path 524 between −x state 512 and −y state 514.

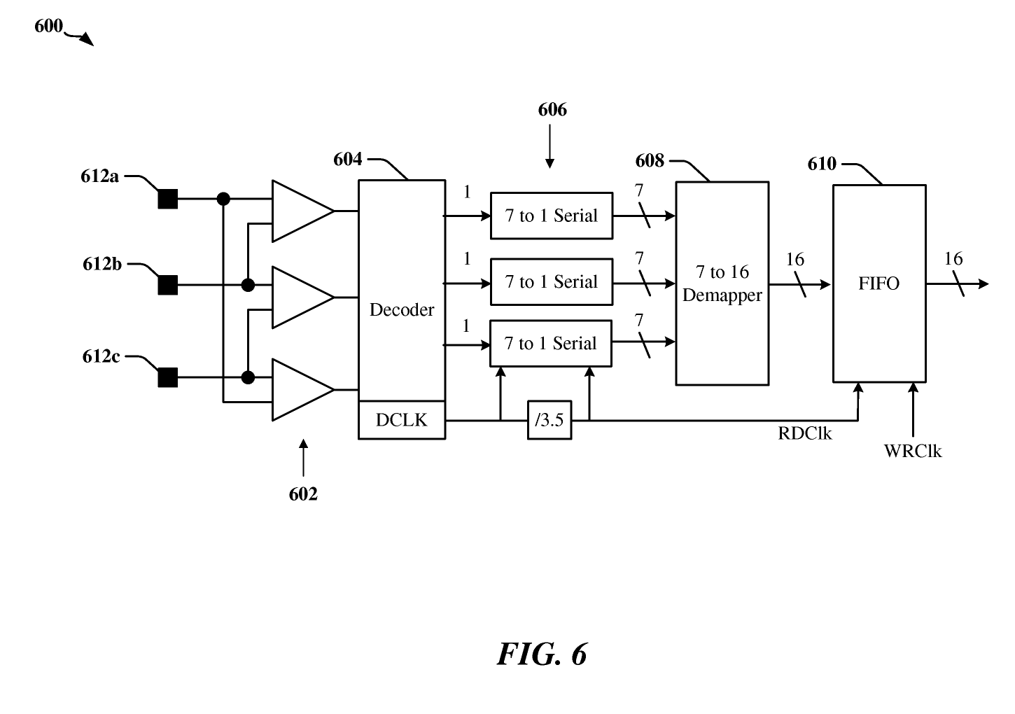

FIG. 6 is a block schematic drawing 600 illustrating an example of a receiver in a 3-phase PHY. Comparators 602 is configured to provide a digital representation of the state of each of three transmission lines 612a, 612b and 612c, and the decoder 604 is configured to generate a sequence of symbols based on changes in the state of the three transmission lines compared to the state transmitted in the previous symbol period. As can be seen from the example depicted in the schematic 600, the voltage of each connector 612a, 612b or 612c may be compared to the voltages of the other two connectors 612a, 612b and/or 612c to determine the state of each connector 612a, 612b or 612c relative to the other two connectors 612a, 612b and/or 612c, such that the occurrence of a transition may be detected and decoded by decoder 604 based on the outputs of the comparators 602. Seven consecutive states are assembled by serial to parallel convertors 606, which produce sets of 7 symbols to be processed by demapper 608 to obtain 16 bits of data that may be buffered in FIFO 610.

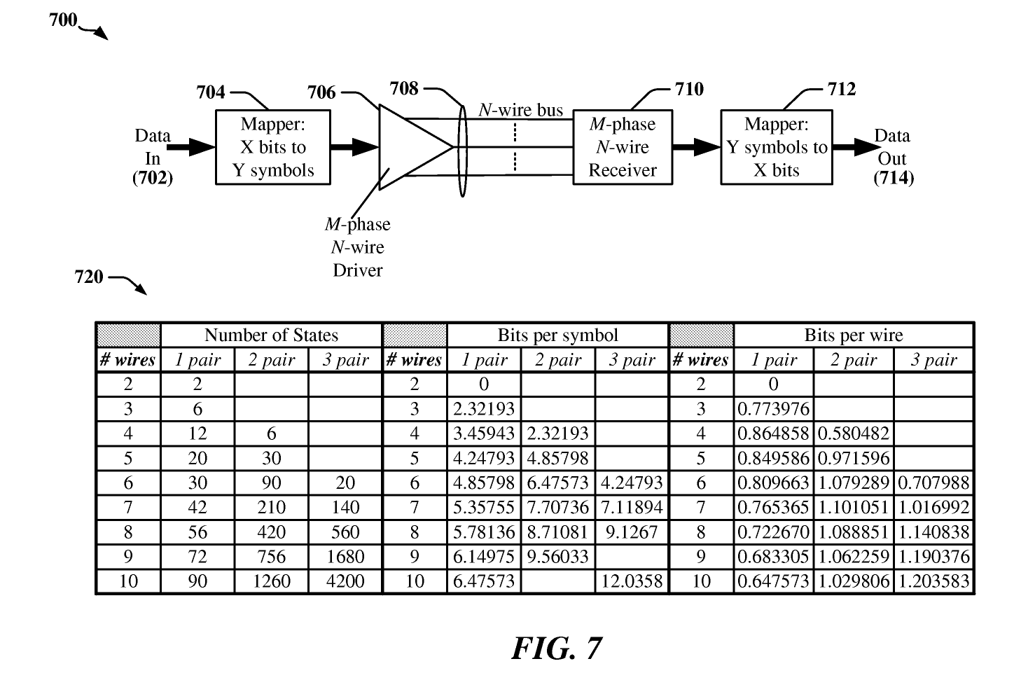

FIG. 7 includes a block schematic diagram 700 illustrating certain aspects of an M-wire, N-phase encoding system and bit encoding capabilities for various values of M and configurations of the M-wire, N-phase encoding system. Data received at a transmitter may be mapped to a number of symbols to be sequentially transmitted over an N-wire bus 708. The mapping scheme may determine a configuration for the N-wire bus 708. In one example, a plurality of connecters in the N-wire bus 708 may carry the same N-phase signal, shifted by a predetermined phase angle. In another example, the N-wire bus 708 may be subdivided into groups of G wires, where each group carries different N-phase signals. In the latter example, a 9-wire bus 708 may be configured as three different 3-wire bus segments. According to certain aspects, the mapper 704 may be adapted to dynamically define the encoding scheme, to reconfigure the N-wire bus 708 and to control the operation of the M-phase, N-wire driver 706. In one example, the mapper 704 may be adapted to reconfigure the M-wire, N-phase encoding system to provide a desired bandwidth and/or to limit power consumption. Thus, the mapper 704 may selectively enable and disable portions of the N-wire bus 708 when demand on data bandwidth is low, and the mapper 704 may enable additional portions of the N-wire bus 708 to obtain increased bandwidth.

At the receiver, N-phase symbols are received and accumulated from the N-wire bus 708, typically over a plurality of transmission clock cycles. The accumulated symbols may then be decoded by a symbol-to-bits mapper 712. Transmit clocks may be derived from one or more portions of the N-wire bus 708 and configuration information may be communicated using a designated group of connectors that provide a primary channel. In the example of a 9-wire bus 708 configured as three different 3-wire bus segments, one bus segment may be identified as the primary channel with a default encoding scheme to be used during power-up and synchronization. Commands communicated over the bus may cause the transmitter and receiver to enter a hibernate stage on one or more of the 3-wire segments.

N-Phase data transfer may use more than three signal wires or other connectors in provided in a communication medium. The use of additional signal wires that can be driven simultaneously provides more combinations of states and polarities and allows more bits of data to be encoded at each transition between states. This can significantly improve throughput of the system, while limiting power consumption as opposed to communications links that use multiple differential pairs to transmit data bits, while providing increased bandwidth. Power consumption can be further limited by dynamically configuring the number of active connectors for each transmission.

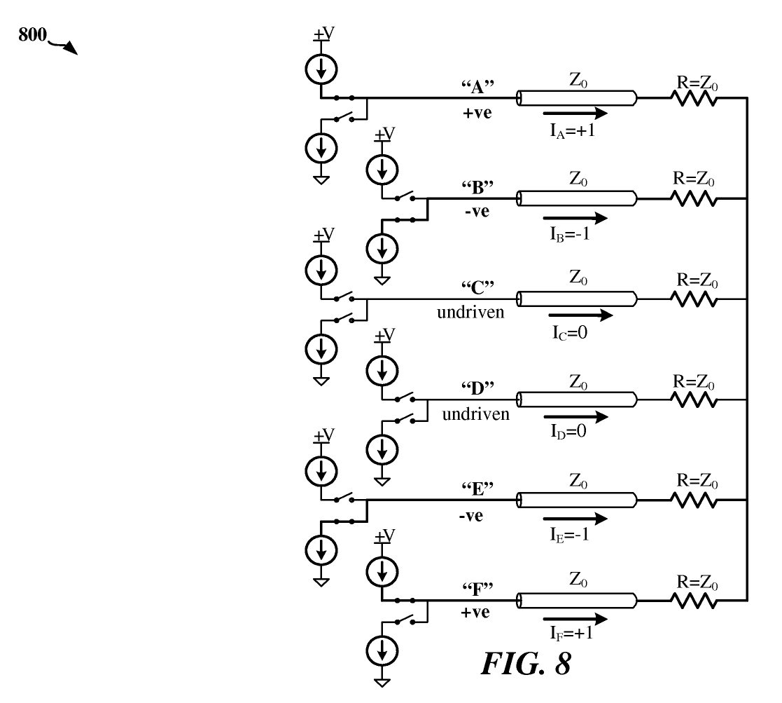

FIG. 8 is a schematic drawing illustrating a model encoder 800 for transmitting symbols using 6 wires with 2 pairs of wires driven for each state. The 6 wires may be labeled A through F, such that in one state, wires A and F are driven positive, wires B and E negative, and C and D are undriven (or carry no current). In the example the N-phase signal may have 3 phases. Each phase state can have either a positive or negative polarity. In the illustrative model encoder 800, each wire may be connected to a positive current source, a negative current source, or no current source. Current flows through a wire having an impedance Z₀ that is typically the characteristic impedance of the transmission wire. As shown in FIG. 8, positive currents are canceled by two negative currents.

For six wires, there may be:

$$C ( 6 , 4 ) = \frac{6 !}{( 6 - 4 ) ! \cdot 4 !} = 15$$

possible combinations of actively driven wires, with:

$$C ( 4 , 2 ) = \frac{4 !}{( 4 - 2 ) ! \cdot 2 !} = 6$$

different combinations of polarity for each phase state.

The 15 different combinations of actively driven wires may include:

| | | | | |
|---|---|---|---|---|
| A B C D | A B C E | A B C F | A B D E | A B D F |
| A B E F | A C D E | A C D F | A C E F | A D E F |
| B C D E | B C D F | B C E F | B D E F | C D E F |

Of the 4 wires driven, the possible combinations of two wires driven positive (and the other two must be negative). The combinations of polarity may include:

++−− +−−+ +−+− −+−+ −++− −−++

Accordingly, the total number of different states may be calculated as 15×6=90. To guarantee a transition between successive symbols, 89 states are available for transition from any current state, and the number of bits that may be encoded in each symbol may be calculated as: log₂(89)≅6.47 bits per symbol. In this example, a 32-bit word can be encoded by the mapper into 5 symbols, given that 5×6.47=32.35 bits.

The general equation for the number of combinations of wires that can be driven for a bus of any size, as a function of the number of wires in the bus and number of wires simultaneously driven:

$$C ( {N}_{wires} , {N}_{driven} ) = \frac{{N}_{wires} !}{( {N}_{wires} - {N}_{driven} ) ! \cdot {N}_{driven} !}$$

The equation for the number of combinations of polarity for the wires being driven is:

$$C ( {N}_{driven} , \frac{{N}_{driven}}{2} ) = \frac{{N}_{driven} !}{{( ( \frac{{N}_{driven}}{2} ) ! )}^{2}}$$

The number of bits per symbol is:

$${log}_{2} ( C ( {N}_{wires} , {N}_{driven} ) \cdot C ( {N}_{driven} , \frac{{N}_{driven}}{2} ) - 1 )$$

FIG. 7 provides a table 720 that shows bit encoding for various values of M (i.e. number of wires) and configurations of wires and wire pairs.

In some embodiments, an encoder may be configured to increase the number of wires used for N-phase encoding when increased bandwidth is required. Bandwidth may change when, for example, a video clip is to be displayed to a user of apparatus 100, or when a burst of data is to be transferred between processing circuits and/or memory devices. Changes in bandwidth may also correspond or relate to power control measures as well as specific application needs. For example, the apparatus of FIG. 2 may dynamically reconfigure the connectors 220 to initiate power-saving measures that may conserve battery lifetime when demand for bandwidth is curtailed.

When increased or decreased bandwidth is required or requested, an encoder may increase or decrease the number of active conductors to be used for N-phase encoding. Such adaptive encoding can enable the power-efficient provision of variable bandwidth. In one example, additional wires can be added in atomic units. An atomic unit may include three wires that employ 3-phase, polarity encoding (described herein). In another example, additional encoding states may be defined by adding pairs of wires to an M-wire, N-phase bus. In another example, additional encoding states may be obtained by adding a single wire, whereby two wires are undriven for each state. Addition of an undriven wire may increase power consumption less than adding a pair of driven wires.

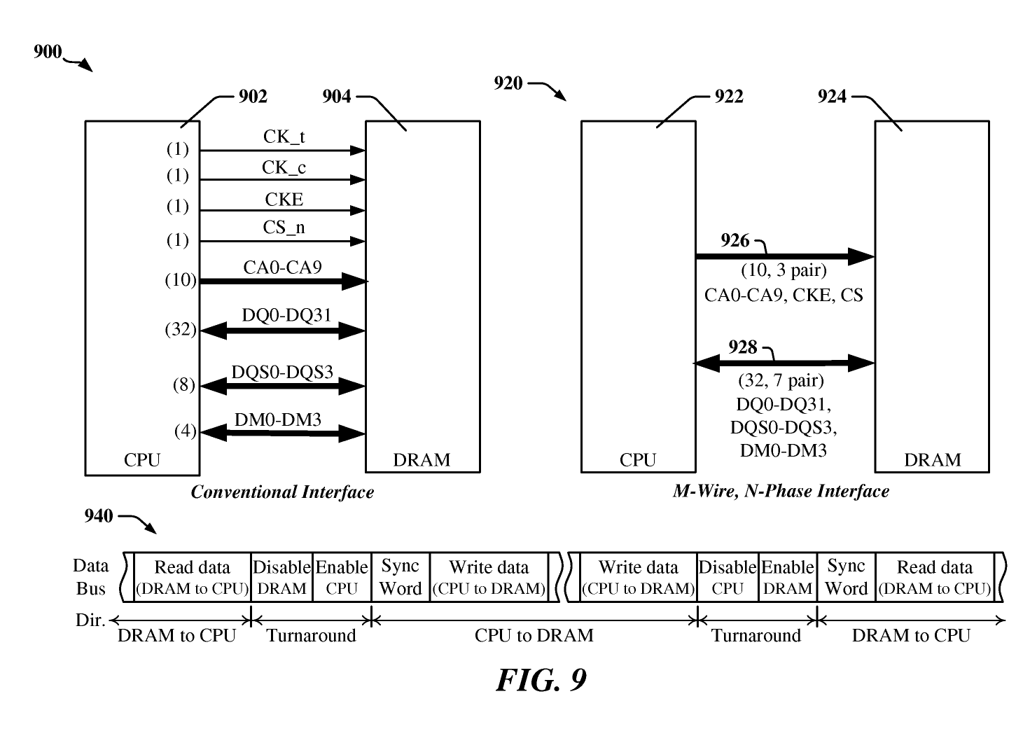

FIG. 9 is a block schematic illustrating an example in which an M-wire N-phase encoding scheme may replace conventional data and control buses used to couple a computing device or central processing unit (CPU) 902, 922 with a corresponding DRAM device 904, 924. In a conventional system 900, a CPU 902 may require 58 or more signal interconnects to operate a DRAM 904. In a system 920 that uses an M-wire, N-phase encoding scheme, the CPU 922 requires only 42 signal wires to interconnect with a DRAM 924, which may include a low-power DDR SDRAM 924. N-Phase Polarity encoding may be used to improve performance of the interface between CPU 922 and DRAM 924. The improvements may provide one or more of an increase in maximum speed, a reduction in the number of signals required, and a reduction in power consumption of the interface.

When replacing conventional signals with an N-Phase Polarity encoded interface, similar types of signals may be grouped together in a corresponding bus. For example, one grouping that includes clock, clock enable, chip selects and address-command bus may be transmitted in a first N-Phase Polarity encoded bus 926, which may have 10 wires, while data, data strobe and other similar signals may be transmitted in a second N-Phase Polarity encoded bus 928 having 32 wires.

A mapping function (see mapper 704, for example) may map one link symbol of the first N-Phase Polarity encoded bus 926 to one 12-bit word representing the state of 12 control signals. The DRAM interface clock signal may be implicitly transmitted as the derived symbol clock of the N-Phase Polarity encoded bus that conveys the timing required to properly receive the symbols encoding DRAM control and address signals. Signals related to the data bus of a DRAM 924 may be clustered together on the second N-Phase Polarity encoded bus 928, or on multiple encoded bus portions, and/or on independently encoded buses according to the width of the conventional data bus between CPU 902 and DRAM 904. In one example a 32-wire N-Phase Polarity link capable of carrying 40 data bits and associated signals includes the data bus (DQ0-DQ31), data strobe (DQS0_t-DQS3_t, and DQS0_c-DQS3_c) and data mask (DM0-DM3).

Certain signals, including data strobe signals may be defined as differential signals for some devices 904, 924, including low-power DDR2 (LPDDR2) devices, but these signals may be handled as non-differential signals on the N-Phase Polarity link, because common-mode noise rejection is provided by the nature of the N-Phase Polarity encoding used for the link. In this case, the mapping function 302 (see FIG. 3) may map one link symbol to one 40-bit word (for 32-bit data, 4-bit strobe, and 4-bit mask). If a wider memory bus is required then multiple copies of the 32-bit bus can be used. In some embodiments, a single N-Phase Polarity link capable of carrying 80 signals may be used to further reduce the total number of bus wires required, although a more complex mapper 302 may be required. Timing used to receive the data-related signals may be derived from the recovered clock of the data-bus N-Phase Polarity link.

The DQ0-DQ31 are typically bidirectional signals, as are the strobe signals DQS0-DQS3. The mask signals DM0-DM3 may be defined as unidirectional signals transmitted from the CPU 922 to DRAM 924 for LPDDR2 interface, and these signals can be driven to a constant value (such as zero) at the DRAM 924 when the bus transmission direction is turned for DRAM 924 to CPU 922 communication to enable reading from the DRAM 924 for example. FIG. 9 includes a timing diagram 940 illustrating the operation of a bidirectional bus 928. According to certain aspects disclosed herein, an N-Phase Polarity link can start and stop quickly, since link timing is derived from the guaranteed state transitions of the link symbol data. A short dead time may be provided for link turn-around and a synchronization word may be transmitted as the first symbol after changing direction to ensure the system is properly extracting clock timing and receiving commands. The synchronization word is typically intercepted and discarded by the link interface. In one example of high-level timing shown in the timing diagram 940, data link changes in direction from read to write are illustrated. The synchronization word or a second synchronization word may be used to signal the configuration of the N-Phase Polarity encoded bus 926 and/or 928 by identifying groupings of enabled and disabled wires, for example.

The timing of certain LPDDR2 signals may not be directly emulated in an N-Phase Polarity encoded link. For example, it may not be desirable to emulate asynchronous signals or signals that are timed from another signal rather than having a relationship to the clock signal or specific number of bus clock cycles. One example is the LPDDR2 set-up and hold time with respect to data specified for data strobes. However, the time characteristics of these signals may be adapted slightly since it can be said that the signals arrive aligned perfectly in time with respect to other signals arriving in the same N-Phase Polarity encoding symbol interval.

The use of M-wire N-Phase Polarity encoding permits scalability and enables much higher bus speeds. One N-Phase Polarity symbol can carry control and data conventionally transmitted in one LPDDR2 cycle in half of an LPDDR2 clock cycle. N-Phase Polarity encoding is not typically afflicted by clock skew with respect to the bus signals, because clock signaling is encoded in the data symbols. By encoding clock signals in the data symbols, systems that employ M-wire N-Phase Polarity encoding can avoid the need to employ complex skew control methods, and can further avoid limiting maximum link speed based on practical limitations of clock-data alignment. Accordingly, the M-wire, N-phase polarity encoding systems and methods described herein may be scaled to accommodate significantly higher transfer speeds, and thereby accommodate later generations of SDRAM and other devices.

The bus widths described in relation to FIG. 9 are intended only to serve as an example. A large range of numbers of wires and configuration of pairs of wires may be used.

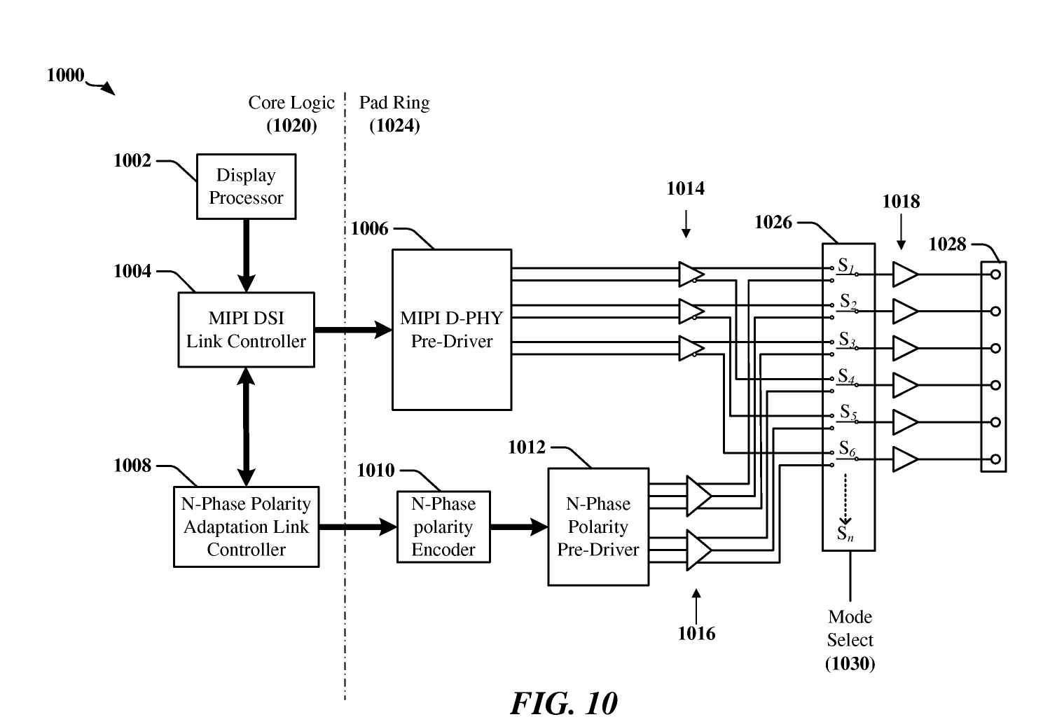

FIG. 10 is a block diagram 1000 illustrating an example in which a mobile device employs pin multiplexing to support reconfiguration of a communications interface. In this example, a configurable interface is described for use in applications that may require a variable bandwidth bus and/or a bus that can be configured for two or more different types of line encoding. In the example illustrated, a configurable interface may be used to selectively provide a differentially-encoded interface and/or an M-wire, N-phase polarity encoded interface. In one example, the configurable interface can selectively activate a desired number of wires used by the interface to communicate data, and/or can reconfigure portions or all of an M-wire, N-Phase Polarity encoded interface to serve as a differential interface. Such configurability may enable a display processor 1002 to generate display data for any of a plurality of display types or displays 124 (see FIG. 1). The display processor 1002 may be integrated with a processing circuit 206 (see FIG. 2), for example. With further reference to FIG. 2, data may be transmitted through a communications link 220 to a device 230 that includes a display controller 232. The communications link 220 may be dynamically or statically configurable to comply with or be compatible with a MIPI standard display serial interface (DSI) or an N-Phase Polarity interface as described herein. The width of individual portions 222, 224, 226 of the communications link 220 may be dynamically or statically configurable. FIG. 10 shows an example configuration in which a switching element 1026 selects between the outputs of three differential drivers 1014 and the outputs of two three-wire, three-phase encoders 1016 to drive 6 output pins 1028. Other combinations and configurations of the output pins 1028, the drivers 1014 and the encoders 1016 may be supported. In one example, the switching element 1024 may include a switching matrix that allows output pins 1028 to be mapped to any output of any differential driver 1014 or any output of any M-wire, N-phase encoder.

When a MIPI DSI interface is configured, display pixel data originating from the display processor 1002 is provided to the MIPI DSI Link Controller 1004, which formats the display pixel data into packets to be sent over a high-speed serial interface 1028 to a display, typically through device 230 and/or display controller 232. Both pixel data and control information may be transmitted over this link 1028. A reverse link may be provided for reading status from display 124, or to receive other information.

Data packets generated by the MIPI DSI Link Controller 1004 in the digital core logic circuitry 1020 may be provided to a MIPI D-PHY Pre-Driver 1006, which may be realized in an input/output section (Pad Ring) 1024. The data packets may be provided to a set of output line drivers 1018 through differential drivers 1014 and/or an electronic switch multiplexer 1026. The differential drivers 1014 may be enabled while N-Phase drivers 1016 are disabled. In one example, the N-Phase drivers 1016 may be disabled when the N-Phase drivers 1016 are forced or otherwise placed in high-impedance output mode.

In another example, the switch multiplexer 1026 may select between differential drivers 1014 and N-Phase drivers 1016 to provide inputs to the line drivers 1018 when N-Phase Polarity encoding is required. The switch multiplexer 1026 may be operated to select the outputs of the N-Phase drivers 1016 as inputs to the output line drivers 1018. Alternatively or additionally, the N-Phase drivers 1016 may be enabled while differential drivers 1014 are disabled and vice versa. In this configuration, data packets generated by the MIPI DSI Link Controller 1004 may be encoded using an N-Phase Polarity encoder 1010 and provided to the N-Phase Polarity pre-driver 1012.

The determination of whether one or more of the line drivers 1018 is in high impedance mode may be made by the encoder used to format data. In one example, output control (high impedance control) of the line drivers 1018 may be controlled by the MIPI D-PHY Pre-Driver 1006, when the interface is driven in a differential encoding mode. In another example, output control of the line drivers 1018 may be controlled by the N-Phase Polarity pre-driver 1012, when the interface is driven in N-Phase Polarity encoding mode.

According to certain aspects described herein, data packets similar to MIPI DSI packets are sent over an N-Phase Polarity link. Some packets may be reformatted to make proper use of symbol groups on the N-Phase Polarity link. For example, a byte may be added to odd-length packets when the MIPI DSI is byte-oriented, while the N-Phase Polarity encoded link is configured for transferring 16-bit words at a time. Transmitters and receivers may be configurable to account for differences in link synchronization between N-Phase Polarity encoding and differential encoding.

An M-wire N-phase link controller 1008 may provide input data words as input to a mapper 704 (see FIG. 7), which maps the input word to a series of symbols to be sent over the bus. The mapper 704 may be embodied in an encoding element 1010. One purpose of the mapper 704 is to compute the values of a group of symbols based on an input data word and output bus configuration. This may be particularly useful if the number of bits per symbol is not an integer. In the simple example described in relation to FIG. 4, a three-wire, three-phase system is employed in which there are 3 possible combinations of 2 wires to be driven simultaneously, given that one wire is undriven. There are also 2 possible combinations of polarity for each pair of wires that may be driven, yielding 6 possible states. 5 of the 6 states are usable because a transition is required between any two symbols. With 5 states there may be log₂(5)≅2.32 bits per symbol. The mapper may accept a 16-bit word and convert it to 7 symbols.

Data packets generated by the N-Phase Polarity Adaptation Link Controller 1008 may be provided to the N-Phase Polarity Encoder 1010 to encode groups of link data (for example, 16-bit or 32-bit words) into groups of symbols, and outputs one symbol at a time to the N-Phase Polarity Pre-Driver 1012. In one example, the N-Phase Polarity Adaptation Link Controller 1008 may be realized in the Digital Core Logic 1020, and the N-Phase Polarity Encoder 1010 may be realized in the Pad Ring 1024. The pre-driver 1012 may amplify received input signals to a level sufficient to drive the buffers 1016 and/or the output line drivers 1018.

The switch multiplexer 1026 may select either the MIPI D-PHY Pre-Driver 1006 output or the N-Phase Polarity Pre-Driver 1012 output to be provided to the output line drivers 1018. The switch multiplexer 1026 may transmit signals having a voltage or current level much lower than the output of the output line drivers 1018. Accordingly, the output signals from the MIPI D-PHY Pre-Driver 1006 and/or the N-Phase Polarity Pre-Driver 1012 may be easily switched using an IC device. In some instances, control signals that determine if one or more output drivers should be in a high impedance state may be switched using the switch multiplexer 1026 or a related switching device.

A mode select 1030 input may control the configuration of the switch multiplexer 1026. The switch multiplexer 1026 may be set to a default or preconfigured selection when the system is powered up. In some examples, this state need be configured only once because the display 124 may be permanently or semi-permanently attached to the processing circuit 102 (see FIG. 1) with a fixed number and configuration of active connectors 1028. Consequently, the switch multiplexer may be configured during manufacture and the setting need not be changed during normal operation of the system. In one example, the switch multiplexer 1026 may be addressed by a processing circuit 206 or 236 through one or more configuration registers, which may be non-volatile. Code for programming the switch multiplexer may be stored in storage 208, 238 (see FIG. 2) or other storage. The use of the switch multiplexer 1026 to switch low-level signals permits the same application processor to be used for more than one interface, without the need to duplicate I/O pads or pins. The same I/O pads or pins 1028 may therefore be used for more than one interface, where programming of the switch multiplexer need only be performed once per system.

The principles of operation described in relation to FIG. 10 may be applied in a wide variety of applications and a pin multiplexer may be employed to provide a flexible and reconfigurable communications link between different types of devices and in different types of apparatus, including applications that are not governed by industry standards.

A dynamically configurable communications link may be provided by configuring one or more of the link controllers 1004, 1008, encoders 1010 and the PHY pre-drivers 1006, 1012 to produce signals to be communicated over a desired number of wires or connectors. The switch multiplexer 1026 may be further controlled through a mode select input 1030 to selectively enable a combination of switches and/or the output line drivers 1018 to drive the desired number of connectors 1028.

According to certain aspects described herein, bandwidth may be increased by using multiple 3-phase polarity encoders rather than using an N-phase encoder where N is greater than 3. Advantages of using multiple 3-phase polarity encoders include the ability to conserve power by selectively enabling more or fewer encoders to match bandwidth demand. In some embodiments, one of a plurality of 3-phase encoders may be designated as a primary encoder, which is not disabled when the link is active, thereby ensuring that the clock, when available can be derived from the primary encoder. It will be appreciated that forward and reverse links may be operated independently of one another and the mode select input may take account of the division of connectors 1028 allocated for forward and reverse links.

According to certain aspects disclosed herein, a communication link may be dynamically reconfigured to meet changing operational requirements. For example, the number of active interconnects 1028 carrying N-phase signals may be selected to achieve bandwidth and/or power consumption targets. The number of active interconnects 1028 may be selected using control signals driven under control of a processing circuit 206, 236 (see FIG. 2), and/or a PHY driver 210, 240 including for example, a link controller 1004, 1008, an encoder 1010 and a PHY pre-driver 1006, 1012. In one example, operating software executed by a processing circuit 206, 236 may determine a current power budget and a desired bandwidth and may communicate information to a PHY driver 1006 or 1010 that may be used to configure the mode of operation of the communications link. The number of active interconnects 1028 may be configured accordingly. In another example, overall power consumption may comply with a power budget over a period of time, although higher-than-budgeted power-consumption may be required to meet data rates associated with bursty transmissions. An increased number of wires may be used for short periods of time to accommodate bursts of high volume data, while a significantly smaller number of wires may be used between bursts, such that average power consumption complies with the power budget.

In one example, a mode select signal 1030 may be used to match encoded signal lines to interconnects and/or to disable certain line drivers. The PHY driver 1006 or 1010 may provide control signals in addition to encoded signals, where the control signals may enable or disable one or more drivers in the sets of driver circuits 1014, 1016 and/or 1018, and direction of bidirectional drivers. In at least some examples, the processing circuit 206, 236 (see FIG. 2) may communicate high level control information to the PHY driver 1006 or 1010, and the PHY driver 1006 or 1010 may then determine the number of wires used to achieve necessary bandwidth, after taking into consideration occupancy of buffers, quality of service guarantees associated with the communication link and preconfigured policies that govern decision making related to bandwidth/power tradeoffs. Accordingly, the communication link may achieve acceptable average power consumption while supporting bursts of data as necessary to maintain data throughput rates.

As disclosed herein, dynamic configuration of a communications link may be accomplished by exchanging control information with a receiver, typically in a communications channel specified by a predefined protocol. The control information may include information related to one or more of a power budget, a minimum bandwidth requirement, a number of wires to be used, specific wires or groups of wires to be used for communication. The control information may be transmitted on a dedicated control channel, and/or in control packets. The control message may alternatively or additionally be transmitted with a shutdown command, a wakeup command, and/or in a preamble preceding each transmission. In some examples, the configuration of the communications link 220 may be determined during a training preamble and/or synchronization sequence, whereby the receiving physical layer drivers 210 or 240 monitors the available wires or other conductors for transitions corresponding to an N-phase signal, in order to determine which wires/conductors are active.

The training preamble and/or synchronization sequence may be used to test the communications link. In one example, the training preamble may be sent on a plurality of wires to specify which wires are to be used for transmitting data. A receiver may respond with information acknowledging the number and identity of the wires from which the training preamble is detected. In one example, the response may be provided on a reverse communication link. In another example, a response is provided if the number and identity of the wires to be used for transmission of data do not match control information transmitted by the primary channel. Should an interconnect be determined to be inoperative, the switch element 1026 in the transmitter and a corresponding switch in the receiver may be operated to reconfigure the communication link by excluding the inoperative interconnect.

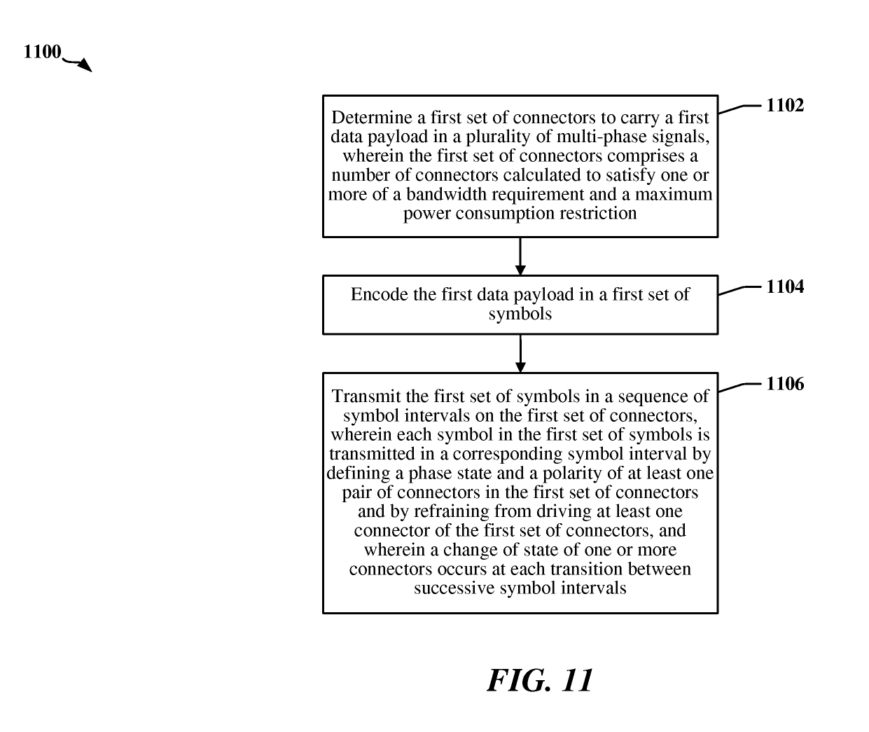

FIG. 11 is a flow chart illustrating a data transfer method for configuring a communications link according to certain aspects of the invention. At step 1102, a first set of connectors is determined. The first set of connectors may be configured and/or used to carry a first data payload in a plurality of multi-phase signals. The first set of connectors may comprise a number of connectors calculated to satisfy one or more of a bandwidth requirement and a maximum power consumption restriction.

At step 1104, the first data payload may be encoded in a first set of symbols.

At step 1106, the first set of symbols may be transmitted in a first sequence of symbol intervals on the first set of connectors. Each symbol in the first set of symbols may be transmitted in a corresponding symbol interval by defining a phase state and a polarity of at least one pair of connectors in the first set of connectors and by refraining from driving at least one connector of the first set of connectors. A change of state of one or more connectors may occur at each transition between successive symbol intervals.

In an aspect of the disclosure, a second set of connectors may be determined. The second set of connectors may be configured and/or used to carry a second data payload in a plurality of multi-phase signals. The second data payload may be encoded in a second set of symbols. The second set of symbols may be transmitted in a second sequence of symbol intervals on the second set of connectors. The second set of connectors may comprise a different number of connectors that is different from the number of connectors in the first set of connectors. The first set of connectors and the second set of connectors may have at least one connector in common

In an aspect of the disclosure, the number of connectors in the first set of connectors is selected to satisfy a temporary bandwidth requirement. The number of connectors in the second set of connectors may be selected to satisfy the maximum power consumption restriction. The maximum power consumption restriction may relate to an average power consumption. The total power consumed during transmission of the first data payload and the second data payload may satisfy the maximum power consumption restriction. Power consumed while transmitting the first set of symbols on the first set of connectors may exceed the maximum power consumption restriction.

In an aspect of the disclosure, the second set of symbols may be transmitted on the second set of connectors by disabling a plurality of multi-phase drivers.

In an aspect of the disclosure, information describing the first set of connectors may be communicated to a receiver of the first data payload. The information describing the first set of connectors may be communicated through a control channel or in a control packet. The information describing the first set of connectors may be communicated in preambles transmitted over the first set of connectors. The information describing the first set of connectors may be communicated in a training sequence over the first set of connectors. The first sequence of symbols may be transmitted on the first set of connectors by configuring a plurality of multi-phase drivers to drive the first set of connectors.

In an aspect of the disclosure, transmitting the first sequence of symbols may be transmitted on the first set of connectors by operating a plurality of switches to cause an output of at least one of a plurality of multi-phase drivers to be coupled to a line driver. The line driver may be configured to drive one of first set of connectors.

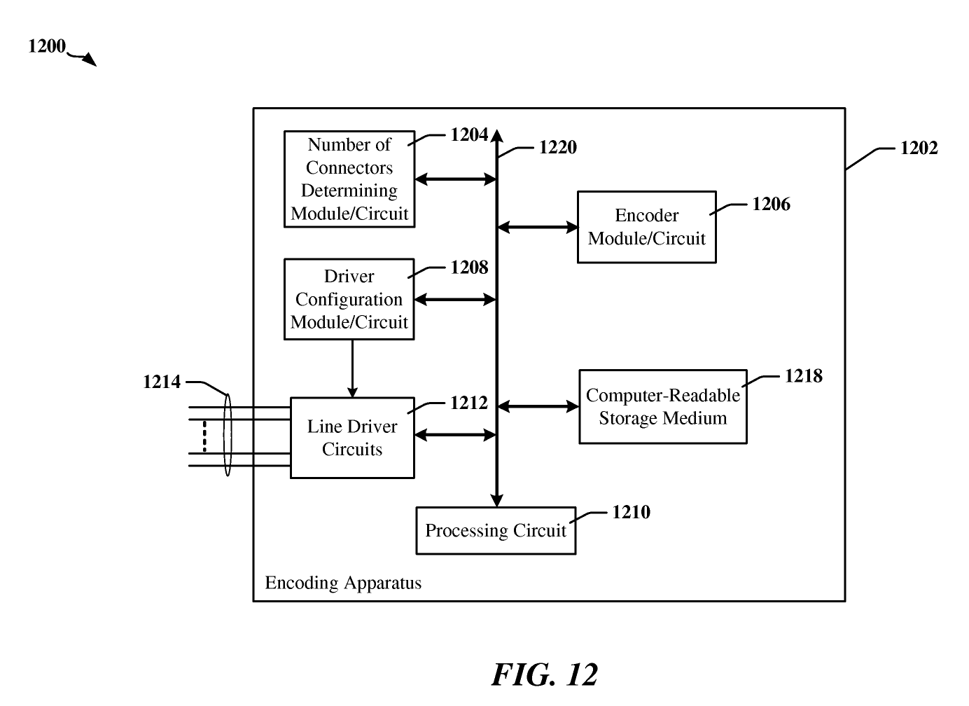

FIG. 12 is a diagram 1200 illustrating an example of a hardware implementation for an encoding apparatus 1202 employing a processing circuit 1210. The processing circuit 1210 may be coupled to a bus architecture, represented generally by the bus 1220. The bus 1220 may include any number of interconnecting buses and bridges depending on the specific application of the encoding apparatus 1202 and certain overall design constraints. The bus 1220 links together various circuits including one or more processors and/or hardware modules, represented by the processing circuit 1210, the modules 1204, 1206 and 1208, and the computer-readable medium 1218. The bus 1220 may also link various other circuits such as timing sources, peripherals, voltage regulators, and power management circuits, which are well known in the art, and therefore, will not be described any further.

The processing circuit 1210 may be coupled to line driver circuits 1212. The line driver circuits 1212 may be selectively coupled to a plurality of connectors and/or wires 1214 under control of the processing circuit 1210. The line driver circuits 1212 provide a means for communicating with various other apparatus over a transmission medium including the wires 1214. The processing circuit 1210 may be coupled to a computer-readable medium 1218. The processing circuit 1210 is responsible for general processing, including the execution of software stored on the computer-readable medium 1218. The software, when executed by the processing circuit 1210, causes the processing circuit 1210 to perform the various functions described supra for any particular apparatus. The computer-readable medium 1218 may also be used for storing data that is manipulated by the processing circuit 1210 when executing software. The processing system further includes at least one of the modules 1204, 1206 and 1208. The modules may be software modules running in the processing circuit 1210, resident/stored in the computer readable medium 1218, one or more hardware modules coupled to the processing circuit 1210, or some combination thereof.

In one configuration, the encoding apparatus 1202 includes means, modules or circuits 1204 for determining first and second sets of a plurality of connectors 1214 to carry a first data payload in a plurality of multi-phase signals, means, modules or circuits 1206 for encoding the first data payload in a sequence of symbols, means, modules or circuits 1208 for configuring line driver circuits 1208. The encoding apparatus 1202 may include means, modules or circuits for transmitting the sequence of symbols on the first or second set of connectors, including a plurality of line drivers 1212 which may be switched between one or more wires/connectors 1214 and/or activated or deactivated to obtain a trade off between bandwidth and power consumption. Certain combinations of the means, modules or circuits 1204, 1206, 1208, 1210 and 1214 in the encoding apparatus 1202 may cooperate to generate and communicate information describing the first set of connectors to a receiver of the first data payload. The aforementioned means, modules and circuits may be one or more of the aforementioned modules of the encoding apparatus 300 and/or the processing circuit 102, which may be configured to perform the functions recited by the aforementioned means.

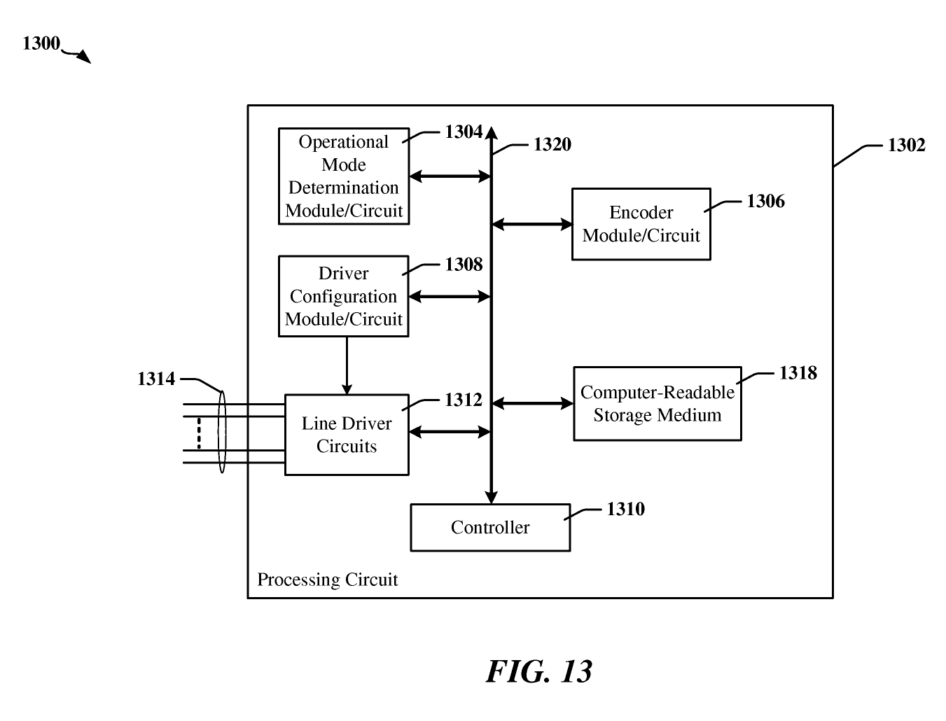

FIG. 13 is a diagram 1300 illustrating an example of a hardware implementation of a driver circuit adapted to dynamically configure a communications link in order to satisfy one or more of a bandwidth requirement and a maximum power consumption restriction. The driver circuit may include a processing circuit 1302 having a controller 1310 or other processing device that may be coupled to a bus architecture, represented generally by the bus 1320. The bus 1320 may include any number of interconnecting buses and bridges depending on the specific application of the processing circuit 1302 and certain overall design constraints. The bus 1320 links together various circuits including one or more processors and/or hardware modules, represented by the controller 1310, the modules 1304, 1306 and 1308, and the computer-readable medium 1318. The bus 1320 may also link various other circuits such as timing sources, peripherals, voltage regulators, and power management circuits, which are well known in the art, and therefore, will not be described any further.

The controller 1310 may be coupled to line driver circuits 1312. The line driver circuits 1312 may be selectively coupled a plurality of connectors and/or wires 1314. The line driver circuits 1312 provide a means for communicating with various other apparatus over a transmission medium including the wires 1314. The controller 1310 may be coupled to a computer-readable medium 1318. The controller 1310 is responsible for general processing, including the execution of software stored on the computer-readable medium 1318. The software, when executed by the controller 1310, causes the controller 1310 to perform the various functions described supra for any particular apparatus. The computer-readable medium 1318 may also be used for storing data that is manipulated by the controller 1310 when executing software. The processing system further includes at least one of the modules 1304, 1306 and 1308. The modules may be software modules running in the controller 1310, resident/stored in the computer readable medium 1318, one or more hardware modules coupled to the controller 1310, or some combination thereof.

In one configuration, the processing circuit 1302 includes a plurality of line drivers 1312, a controller 1310, mode determination modules or circuits 1304 that determine a number of connectors to be used for transmitting data on the communications link 1314, encoder modules or circuits 1306 configured to generate a sequence of symbols from data to be transmitted on the communications link, and driver configuration modules or circuits 1308, for transmitting the sequence of symbols on the first set of connectors. The processing circuit 1302 and/or the controller 1310 may be configured to perform the functions ascribed to the aforementioned modules and circuits.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A data transfer method comprising:
determining a first set of connectors to carry a first data payload in a plurality of multi-phase signals, wherein the first set of connectors comprises a number of connectors calculated to satisfy one or more of a bandwidth requirement and a maximum power consumption restriction;
encoding the first data payload in a first set of symbols; and
transmitting the first set of symbols in a first sequence of symbol intervals on the first set of connectors,
wherein each symbol in the first set of symbols is transmitted in a corresponding symbol interval by defining a phase state and a polarity of at least one pair of connectors in the first set of connectors and by refraining from driving at least one connector of the first set of connectors, and
wherein a change of state of one or more connectors occurs at each transition between successive symbol intervals.

2. The method of claim 1, further comprising:
determining a second set of connectors to carry a second data payload in a plurality of multi-phase signals;
encoding the second data payload in a second set of symbols; and
transmitting the second set of symbols in a second sequence of symbol intervals on the second set of connectors,
wherein the second set of connectors comprises a different number of connectors than the number of connectors in the first set of connectors, and
wherein the first set of connectors and the second set of connectors have at least one connector in common.

3. The method of claim 2, wherein the number of connectors in the first set of connectors is selected to satisfy a temporary bandwidth requirement, and wherein the number of connectors in the second set of connectors is selected to satisfy the maximum power consumption restriction.

4. The method of claim 3, wherein the maximum power consumption restriction relates to an average power consumption, and wherein total power consumed during transmission of the first data payload and the second data payload satisfies the maximum power consumption restriction.

5. The method of claim 3, wherein power consumed while transmitting the first set of symbols on the first set of connectors exceeds the maximum power consumption restriction.

6. The method of claim 2, wherein transmitting the second set of symbols includes:
disabling a plurality of multi-phase drivers.

7. The method of claim 1, further comprising communicating information describing the first set of connectors to a receiver of the first data payload.

8. The method of claim 7, wherein the information describing the first set of connectors is communicated through a control channel or in a control packet.

9. The method of claim 7, wherein the information describing the first set of connectors is communicated in preambles transmitted over the first set of connectors.

10. The method of claim 7, wherein the information describing the first set of connectors is communicated in a training sequence over the first set of connectors.

11. The method of claim 1, wherein transmitting the first set of symbols includes:
configuring a plurality of multi-phase drivers to drive the first set of connectors.

12. The method of claim 1, wherein transmitting the first set of symbols comprises:
operating a plurality of switches to cause an output of at least one of a plurality of multi-phase drivers to be coupled to a line driver, wherein the line driver is configured to drive one of first set of connectors.

13. An apparatus comprising:
means for determining a first set of connectors to carry a first data payload in multi-phase signals and for determining a second set of connectors to carry a second data payload in multi-phase signals, wherein the first set of connectors comprises a number of connectors calculated to satisfy a temporary bandwidth requirement, and wherein the second set of connectors comprises a number of connectors calculated to satisfy a maximum power consumption restriction;
means for encoding the first data payload in a first set of symbols and for encoding the second data payload in a second set of symbols; and
means for transmitting the first set of symbols in a first sequence of symbol intervals on the first set of connectors and for transmitting the second set of symbols in a second sequence of symbol intervals on the second set of connectors,
wherein each symbol in the first set of symbols and in the second set of symbols is transmitted in a corresponding symbol interval by defining a phase state and a polarity of at least one pair of connectors and by refraining from driving at least one connector, and
wherein a change of state of one or more connectors occurs at each transition between successive symbol intervals.

14. The apparatus of claim 13, wherein:
the second set of connectors comprises a different number of connectors than the number of connectors in the first set of connectors, and
wherein the first set of connectors and the second set of connectors have at least one connector in common.

15. The apparatus of claim 13, wherein the maximum power consumption restriction relates to an average power consumption, and wherein total power consumed during transmission of the first data payload and the second data payload satisfies the maximum power consumption restriction.

16. The apparatus of claim 13, wherein power consumed while transmitting the first set of symbols on the first set of connectors exceeds the maximum power consumption restriction.

17. The apparatus of claim 13, further comprising:
means for communicating information describing the first set of connectors to a receiver of the first data payload.

18. The apparatus of claim 17, wherein the information describing the first set of connectors is communicated through a control channel or in a control packet.

19. The apparatus of claim 17, wherein the information describing the first set of connectors is communicated in preambles transmitted over the first set of connectors.

20. The apparatus of claim 17, wherein the information describing the first set of connectors is communicated in a training sequence over the first set of connectors.

21. The apparatus of claim 13, wherein the means for transmitting the first set of symbols and the second set of symbols includes:
a plurality of multi-phase drivers configured to drive the first set of connectors and the second set of connectors; and
a plurality of switches operable to cause an output of at least one of the plurality of multi-phase drivers to be coupled to a line driver, wherein the line driver is configured to drive one of first set of connectors or the second set of connectors.

22. A non-transitory processor-readable storage medium having one or more instructions which, when executed by at least one processing circuit, cause the at least one processing circuit to:
determine a first set of connectors to carry a first data payload in a plurality of multi-phase signals, wherein the first set of connectors comprises a number of connectors calculated to satisfy one or more of a bandwidth requirement and a maximum power consumption restriction;
encode the first data payload in a first set of symbols; and
transmit the first set of symbols in a first sequence of symbol intervals on the first set of connectors,
wherein each symbol in the first set of symbols is transmitted in a corresponding symbol interval by defining a phase state and a polarity of at least one pair of connectors in the first set of connectors and by refraining from driving at least one connector of the first set of connectors, and
wherein a change of state of one or more connectors of the set of connectors occurs at each transition between successive symbol intervals.

23. The storage medium of claim 22, further comprising instructions that cause the at least one processing circuit to:
determine a second set of connectors to carry a second data payload in a plurality of multi-phase signals,
encode the second data payload in a second set of symbols; and
transmit the second set of symbols in a second sequence of symbol intervals on the second set of connectors,
wherein the second set of connectors comprises a different number of connectors than the number of connectors in the first set of connectors, and
wherein the first set of connectors and the second set of connectors have at least one connector in common.

24. The storage medium of claim 23, wherein the number of connectors in the first set of connectors is calculated to satisfy a temporary bandwidth requirement, and wherein the number of connectors in the second set of connectors is calculated to satisfy the maximum power consumption restriction.

25. The storage medium of claim 24, wherein power consumed while transmitting the first set of symbols on the first set of connectors exceeds the maximum power consumption restriction, wherein the maximum power consumption restriction relates to an average power consumption, and wherein total power consumed during transmission of the first data payload and the second data payload satisfies the maximum power consumption restriction.

26. The storage medium of claim 22, further comprising instructions that cause the at least one processing circuit to:
communicate information describing the first set of connectors to a receiver of the first data payload.

27. The storage medium of claim 26, wherein the information describing the first set of connectors is communicated through a control channel or in a control packet.

28. The storage medium of claim 26, wherein the information describing the first set of connectors is communicated in preambles transmitted over the first set of connectors.

29. The storage medium of claim 26, wherein the information describing the first set of connectors is communicated in a training sequence over the first set of connectors.

30. The storage medium of claim 22, wherein the instructions that cause the at least one processing circuit to transmit the first set of symbols on the first set of connectors include instructions that cause the at least one processing circuit to:
configure a plurality of multi-phase drivers to drive the first set of connectors,
cause a plurality of switches to couple an output of at least one of the plurality of multi-phase drivers to a line driver, wherein the line driver is configured to drive one of first set of connectors.

31. A driver circuit adapted to dynamically configure a communications link in order to satisfy one or more of a bandwidth requirement and a maximum power consumption restriction, the driver circuit comprising:
an encoder configured to generate a sequence of symbols from data to be transmitted on the communications link, wherein each symbol is transmitted in a corresponding symbol interval by defining a phase state and a polarity of at least one pair of connectors of the communications link and by refraining from driving at least one connector of the communications link;
a plurality of line drivers, each line driver being configurable to drive one or more connectors of the communications link; and
a controller configured to:
determine a first set of connectors to carry a first data payload in a plurality of multi-phase signals on the communications link, wherein the first set of connectors comprises a number of connectors calculated to satisfy the bandwidth requirement or the maximum power consumption restriction;
configure a portion of the line drivers to couple the encoder to the first set of connectors; and
activate the portion of the line drivers according to the sequence of symbols generated by the encoder.

32. The driver circuit of claim 31, wherein the controller is configured to:
determine a second set of connectors to carry a second data payload in a plurality of multi-phase signals on the communications link;
configure a different portion of the line drivers to connect the encoder to the second set of connectors; and
activate the different portion of the line drivers according to the sequence of symbols generated by the encoder,
wherein the second set of connectors comprises a different number of connectors than the number of connectors in the first set of connectors, and
wherein the first set of connectors and the second set of connectors have at least one connector in common.

33. The driver circuit of claim 32, wherein the number of connectors in the first set of connectors is calculated to satisfy a temporary bandwidth requirement, and wherein the number of connectors in the second set of connectors is calculated to satisfy the maximum power consumption restriction.

34. The driver circuit of claim 33, wherein power consumed while transmitting the first set of symbols on the first set of connectors exceeds the maximum power consumption restriction, wherein the maximum power consumption restriction relates to an average power consumption, and wherein total power consumed during transmission of the first data payload and the second data payload satisfies the maximum power consumption restriction.

35. The driver circuit of claim 32, wherein at least one line driver is disabled when the second data payload is transmitted on the second set of connectors.

36. The driver circuit of claim 31, wherein information describing the first set of connectors is communicated to a receiver of the first data payload.

37. The driver circuit of claim 36, wherein the information describing the first set of connectors is communicated through a control channel or in a control packet.

38. The driver circuit of claim 36, wherein the information describing the first set of connectors is communicated in preambles transmitted over the first set of connectors.

39. The driver circuit of claim 36, wherein the information describing the first set of connectors is communicated in a training sequence over the first set of connectors.

40. The driver circuit of claim 31, further comprising
a plurality of switches operable to cause an output of at least one of the plurality of line drivers to be switchably coupled to connectors of the communications link.
